(19) United States
(12) Patent Application Publication
(10) Pub. No.: US 2004/0030920 A1
(43) Pub. Date: Feb. 12, 2004

(54) Data processing system

(76) Inventors: Rudiger Kroll, Hamburg (DE); Oswald Romer, Hamburg (DE)

Correspondence Address: Alix Yale & Ristas, 750 Main Street, Hartford, CT, 06103-2721, US

(21) Appl. No.: 10/416,770

(22) PCT Filed: Sep. 26, 2001
(86) PCT No.: PCT/EP01/11180

(30) Foreign Application Priority Data
Nov. 6, 2000 (EP) 00 124 085.2

(51) Int. Cl. G06F 17/60

(52) U.S. Cl. 713/200

(57) ABSTRACT

The invention relates to a data processing system comprising a first subsystem (frontend) which can be externally accessed, and a second subsystem (rearend) which is connected to the first subsystem by a logical device which prevents unauthorized access, by means of operation in a security center. The second subsystem is otherwise locked. The second subsystem includes a random number generator, memory devices for data of participants in a lottery, including lottery numbers associated with the players, a winnings plan, and a computer for allocating the winnings to the participants having the ticket numbers corresponding to the numbers produced by the random number generator. The first subsystem also includes a computer for exchanging data with the participants and for informing the winners.

### CROSS-REFERENCE TO R LATED APPLICATIONS

This is the national stage of International Application No. PCT/EP01/11180, filed Sep. 26, 2001 and which designated the United States.

### BACKGROUND OF THE INVENTION

The invention relates to a data processing system having a first subsystem (frontend) which can be accessed externally via the Internet and having a second subsystem (backend) which is connected to the first subsystem by means of a logic device preventing unauthorized access and is otherwise locked.

Data processing systems of this kind are known in connection with the Internet. Although an Internet subscriber has access to a first subsystem where he can input data, can have data displayed, can receive general information and can be forwarded to other links if appropriate, he has no direct access to the data in a second subsystem connected to the first by a firewall. Instead, the data which the Internet subscriber needs to access are transferred from the second subsystem to the first subsystem only selectively.

Internet applications are diverse and are enjoying steadily rising popularity. In this context, however, certain areas are particularly sensitive. For lotteries, there are strict regulations so that the wins cannot be manipulated.

### SUMMARY OF THE INVENTION

The object of the invention is to provide a data processing system of the type mentioned at the outset which allows play only from the Internet without external manipulation being possible.

The inventive data processing system is distinguished in that the second subsystem (backend) features a random number generator, memory devices for data associated with game players in a lottery, including lottery numbers which have been assigned to the players, a win plan and a computer for attributing wins, on the basis of the numbers generated in a random number generator, to game players having lottery numbers which correspond to the numbers, and in that the first subsystem contains a computer for data interchange with the game players, and the second subsystem contains an e-mail facility for notifying the winners.

The winning numbers are generated by a random number generator, for which it is naturally necessary to ensure that genuine random numbers are generated and that certain numbers are not generated significantly more frequently than other numbers. In this context, particular expediency has been found in a random number generator which determines its numbers using a physical noise source, e.g. semiconductor noise. This random number generator can generate any length (max. 20 digits) of final digits (e.g. lottery numbers with two final digits, lottery numbers with three final digits etc.) which are intended to result in wins. This random number generator is naturally not accessible externally, particularly from the first subsystem (frontend system). The second subsystem (backend system) also contains memory devices (database) for data associated with game players in a lottery, including lottery numbers which have been assigned to the players. In this case, the data associated with game players comprise name, address, bank details and possibly telephone numbers, e-mail addresses and the like. In addition, the lottery numbers with which the game player plays the lottery are stored. When game players are referred to in this document, this naturally means not just male game players but also female game players. In addition, the memory devices contain a win plan stipulating the size of the wins for one particular instance of random numbers being generated (final digits being drawn) if the lot contains the correct final number, the correct last two final numbers etc. The corresponding attribution of the wins to the lots and hence to the game players is then performed using a computer arranged in the second subsystem. The first subsystem then contains a computer for data interchange with the game players, and the second subsystem contains an e-mail facility for notifying the winners.

Operation is automatic. In particular, provision can be made for the data processing system to feature a timer which, at regular intervals of time, particularly once daily at a prescribed time of day, initiates the generation of random numbers and the attribution of wins (draw). Provision can naturally also be made for such a draw to be made more than once a day. In this case, the player can use the Internet in order to find out about the winning numbers and possibly even to follow the generation of these winning numbers. A game player can also obtain other general information. In particular, however, provision is also made for the or a computer in the first subsystem to generate a mask for the game player's screen into which he can enter data. The game player can log on and enter his name, his address, bank details and payment type here. As soon as the payment has then been received by means of transfer, or else the payment has been authorized by the credit card institute or the like which the game player wishes to use, the game player can, in one advantageous embodiment, choose one or more lottery numbers. The number of lots which the game player can select can be limited in this case.

With the exception of the fact that the game player has to enter his personal data and the desired lottery numbers, operation is automatic. Wins are likewise paid automatically, specifically to the bank account indicated by the game player. In addition, provision can be made for game players to be granted free play in one or more draws (bonus lots) as a win. This can be the case, for example, if the player's lottery number contains the correct final number in the draw in question.

It is also possible to provide that, with the exception of bonus lots, it is only possible to play in a prescribed number of draws. In one advantageous embodiment, it would be possible, by way of example, to provide four successive classes (weekly draws) each containing seven draws (one on each day), which means that the whole cycle is repeated after 28 days in each case. The fact that a minimum number of draws needs to be chosen increases the attractiveness of the lottery, since there is a greater number of winning chances.

For the purpose of data security, provision is advantageously made for only data associated with the game player who is currently accessing the system to be transferred from the second to the first subsystem, where they are transferred back to the second subsystem or are erased after a prescribed time. This provides the greatest possible data security and the greatest possible protection against data manipulation. The fact that access to the first subsystem is also protected by a firewall and that game players have access only with a password goes without saying in this context and is in line with the practice which is customary for many other Internet pages.

Provision is advantageously made for one or more of the computers to perform an authorization check either in the second subsystem or, advantageously, actually in the first subsystem. It is thus possible, by way of example, to use the zip code to check whether the game player actually lives in an area in which the lottery can be played.

Expediently, every computer and memory is complemented by a second one so that operation can be continued if the first one fails.

As already explained, operation is fully automatic. Only the game player naturally needs to input his data manually. Authorization for credit cards, payment receipts and the like is checked automatically, however, as is the payment of wins.

As already mentioned, firewalls ensure that no unauthorized access to the system or to components of the system is possible. However, it has been found to be particularly advantageous in countering the risk of manipulation if the fundamental parts of the system have been mechanically sealed. Thus, by way of example, the random number generator could be accommodated in a sealed transparent housing so that it cannot be manipulated. This housing naturally needs to be provided with ventilation holes if required.

Provision is expediently also made for all fundamental operations, particularly the generation of the final digits, to be logged.

This can be done in electronic form or else by printing on paper.

### BRIEF DESCRIPTION OF THE DRAWINGS

The invention is described by way of example below using an advantageous embodiment with reference to the appended drawing, in which:

FIG. 1 shows a schematic illustration of the design of the inventive data processing system; and

FIG. 2 shows an example of a win plan.

### DETAILED DESCRIPTION OF THE PREFERRED EMBODIMENT

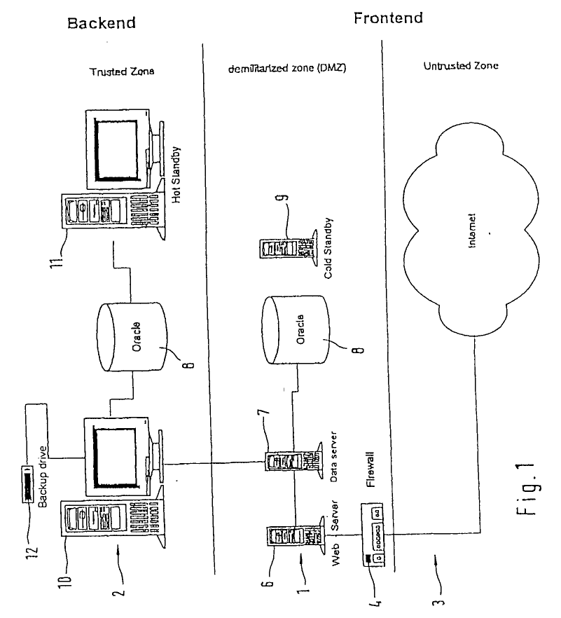

The data processing system shown in FIG. 1 features three areas, namely the freely accessible Internet area 3, the first subsystem 1 and the second subsystem 2. In this case, the first subsystem 1 is isolated from the freely accessible Internet area 3 by a firewall 4. Data beyond general information can be accessed only using a password. The first subsystem 1 is isolated from the second subsystem 2 by a “logic” firewall. The first subsystem features a web server 6 and a data server 7 which is linked to a data structure 8. At 9, a backup computer is shown which can be used if the computer 6 or 7 fails. The second subsystem 2 contains a main computer 10, with another backup computer being connected at 11 and being able to perform the functions of the computer 10 if the latter fails. The link is made via a database system 8. At 12, a backup drive is also shown which additionally stores the data for storage in the computers 10 and 11. In the embodiment shown here, the random number generator is accessed by the computers 10 and 11. The second subsystem 2 is connected to banks, credit card institutes etc. by means of Internet access.

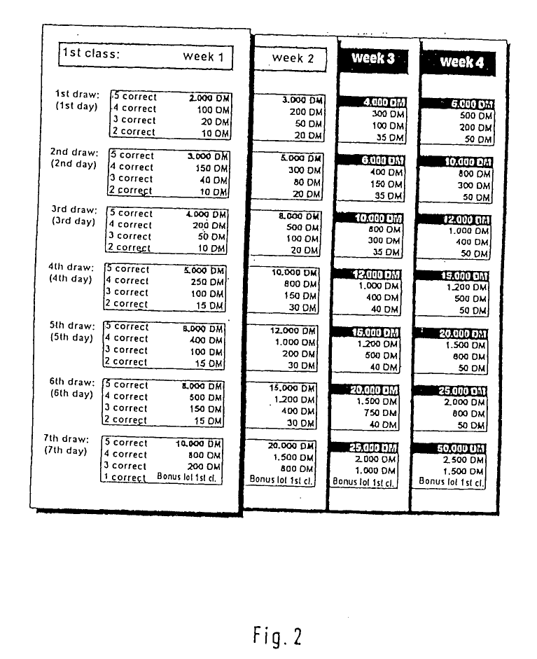

A win plan is shown in FIG. 2. The lottery extends over four respective weeks of seven days. Every day there is one draw. By way of example, it is necessary to play on 28 successive days in each case, but the first day can be any day in the 28-day cycle. Only in the case of a bonus lot is it possible to play just in one class, namely in the first class of the subsequent lottery.

The lottery is run entirely paperlessly over the Internet, with, at most, provision being able to be made for the numbers from the random number generator or their logs to be sent to the financial authority as a paper copy.

The game player accesses the Internet page and can then first view general information, particularly an online presentation of the lottery. He can then log in, or register again. This involves the use of passwords. Lots are ordered, the game player's data are input, including the input of payment information, and lots are selected using an input mask. However, the lot is not activated until payment has been made by bank transfer or else payment has been authorized by the credit card institute. This Internet page is then also used to show the generation of the final digits. It also allows the game player to find out whether he has won. While he or she has called up the Internet page, personal data are also transferred from the second secure subsystem to the first subsystem. When the game player breaks the connection, or else after a prescribed time in which the game player has not been active again, these data are transferred back to the secure second subsystem or else are erased. Management of customer debits, draw processing, win notification, management of original data etc. take place in the secure second subsystem. Payment transactions, online validation of payment data, data interchange with the bank (transfers, credits and debits) likewise advantageously take place over the Internet.

At precisely defined intervals of time, at the very same time once daily in the case of the example in FIG. 2, final digits are generated. This means that the lots are ascertained with a correct final number, with two correct final numbers etc., which are then assigned a win on the basis of the win plan. This win is then automatically transferred to the bank account indicated by the game player.

For security purposes, provision is expediently made for electronic lots to be created which are provided with information about lottery number, customer number, playing period, game player's current account—which are all digitally encrypted—so that the electronic lots are protected against alteration.

Expediently, the database 8 used in FIG. 1 is an Oracle database. It would likewise be possible to use other databases in theory, however, although this should not primarily be geared thereto.

For the check on whether the game player is actually entitled to play a game, he needs to indicate whether he is over 18 years old; also, local entitlement, if there are restrictions in this regard, is verified by checking the zip code.

What is claimed is:

1. A data processing system [having] comprising:
a first subsystem [(frontend, 1)] which can be accessed externally via the Internet and [having]
a second subsystem [(backend, 2) which is] connected to the first subsystem [(frontend, 1)] by [means of] a logic device preventing unauthorized access, [and is otherwise locked, where] the second subsystem [(backend, 2) features:] including
a random number generator,
memory devices [(9, 10, 11)] for data associated with [game] a plurality of players in a lottery, the data including lottery numbers associated with the players and a win plan,
a computer [(9, 10)] for attributing wins, on the basis of the numbers generated in the random number generator, to [game] players having lottery numbers which correspond to the numbers, and
an e-mail facility for automatically notifying the winners and a timer which, at regular intervals of time[, particularly once daily,] initiates the generation of final digits and the attribution of wins[(draw),];
[where] wherein the first subsystem [(frontend, 1) contains] includes a computer [(6, 7)] for data interchange with the [game] players and for notifying the winners.

2. The data processing system [as claimed in] of claim 1[, characterized in that] wherein the random number generator [features] has a physical noise source.

3. The data processing system [as claimed in one of claims] of claim 1 [or 2, characterized in that] wherein the computer [in] of the first subsystem [(frontend, 1)] generates a mask for a computer screen of the [game] player['s screen] into which [he] the player can enter data.

4. The data processing system [as claimed in] of claim 3[, characterized in that] wherein the mask contains input options for the [game] player relating to one or more lottery numbers which [he or she] can [select] be selected.

5. The data processing system [as claimed in one of claims] of claim 1 [to 4, characterized in that] wherein play in the lottery is not activated until payment for the stake has been made or confirmed.

6. The data processing system [as claimed in one of claims] of claim 1 [to 5, characterized in that] wherein wins are paid automatically to [the] a bank account indicated by the [game] player.

7. The data processing system [as claimed in one of claims] of claim 1 [to 6, characterized in that] wherein [game] players can be granted free play in one or more [draws (bonus lots)] bonus lots as a win.

8. The data processing system [as claimed in one of claims 1 to] of claim 7[, characterized in that,] wherein with the exception of bonus lots, it is possible to play only in a prescribed number of draws.

9. The data processing system [as claimed in one of claims] of claim 1 [to 8, characterized in that] wherein only data for the [game] player who is currently accessing the system are transferred from the second to the first subsystem [(frontend, 1)], where they are transferred back to the second subsystem [(backend, 2)] or are erased after a prescribed time.

10. The data processing system [as claimed in one of claims] of claim 1 [to 9, characterized in that] wherein one or more of the computers [(5, 6, 9, 10)] perform an authorization check.

11. The data processing system [as claimed in one of claims] of claim 1 [to 10, characterized in that every computer and memory (5, 6, 9, 10) is complemented by a second one which continues to operate if the first one fails] wherein the first subsystem also includes a backup computer and the second subsystem also includes a backup memory device and a backup computer.

12. The data processing system [as claimed in one of claims] of claim 1 [to 11, characterized in that] wherein operation is fully automatic.

13. The data processing system [as claimed in one of claims] of claim 1 [to 12, characterized in that the fundamental parts of] wherein the random number generator has fundamental parts which have been mechanically sealed.

14. The data processing system [as claimed in one of claims] of claim 1 [to 13, characterized in that] wherein all fundamental operations are logged.

15. The data processing system [as claimed in one of claims] of claim 1 [to 14, characterized in that it] wherein the data processing system is connected to the Internet.
